(19) United States
(12) Patent Application Publication
(10) Pub. No.: US 2024/0273055 A1
(43) Pub. Date: Aug. 15, 2024

(54) METHOD FOR DATA EXCHANGE

(71) Applicant: Robert Bosch GmbH, Stuttgart (DE)

(72) Inventors: Fabian Wunderlich, Schwaebisch Hall (DE); Manuel Maier, Abstatt (DE)

(21) Appl. No.: 18/431,862

(22) Filed: Feb. 2, 2024

(30) Foreign Application Priority Data
Feb. 10, 2023 (DE) 10 2023 201 083.6

(51) Int. Cl. G06F 15/163

(52) U.S. Cl. CPC G06F 15/163

(57) ABSTRACT

A method for data exchange between a main processor and at least one sub-processor running asynchronously thereto. The method includes: continuously querying a status line for the data transmission by means of the main processor;

preparing transmission data of the sub-processor to the main processor; changing the status of the status line via the sub-processor; starting data transmission from the main processor to the sub-processor, and simultaneously transmitting the transmission data from the sub-processor to the main processor.

### CROSS REFERENCE

The present application claims the benefit under 35 U.S.C. § 119 of German Patent Application No. DE 10 2023 201 083.6 filed on Feb. 10, 2023, which is expressly incorporated herein by reference in its entirety.

### FIELD

The present invention relates to a method for data exchange between a main processor and at least one sub-processor running asynchronously thereto. The present invention additionally relates to a device for carrying out such a method.

### BACKGROUND INFORMATION

It is conventional to transmit data between main processors and sub-processors. For this purpose, the processors are usually synchronized via a system clock. It is also conventional to transmit data between processors running asynchronously. This data exchange is interrupt-dependent.

U.S. Patent Application Publication No. US 2011/0106979 A1 describes a data communication system which contains a main processor and at least one sub-processor. This sub-processor is connected to the main processor according to a serial peripheral interface (SPI) method. In this case, an operation that corresponds to a command transmitted by the main processor is carried out. The connection according to the SPI method takes place via one or more bus lines, including a master-in-slave-out (MISO) line and a master-out-slave-in (MOSI) line, a slave select (SS) line, an interrupt line, and a clock transmission line.

An object of the present invention is to provide a method for data exchange between a main processor and at least one sub-processor running asynchronously thereto, with which method an interrupt-independent data exchange is made possible. Additionally, an object of the present invention is to provide a device for carrying out such a method.

The object may be achieved by a method for data exchange between a main processor and at least one sub-processor running asynchronously thereto, including features of the present invention. Preferred example embodiments of the present invention are disclosed herein.

### SUMMARY

The present invention specifies a method for data exchange between a main processor and at least one sub-processor running asynchronously thereto. According to an example embodiment of the present invention, the method comprises the steps of continuously querying a status line for the data transmission by means of the main processor, of preparing transmission data of the sub-processor to the main processor, of changing the status of the status line via the sub-processor, of starting data transmission from the main processor to the sub-processor, and of simultaneously transmitting the transmission data from the sub-processor to the main processor.

According to an example embodiment of the present invention, the main processor and the sub-processor can thus be clocked differently. The data to be exchanged between the main processor and the sub-processor can be data from radar speed sensors, data on wake-up and sleep information, or data relating to a brake system. The status line is a line in which it is indicated when the sub-processor is ready to receive. In order to not still have to provide transmission data during the readiness to receive, the transmission data are already compiled beforehand. As a result, the time during which the sub-processor is ready to receive can be used for the data transmission, so that all data can be transmitted completely during this time. Bidirectional data exchange can thus take place. By indicating the readiness to receive, synchronization of the two processors is not necessary. Additionally, the processes on the processors are not interrupted by incoming data, so that deterministic runtimes can be guaranteed. A corresponding system can be operated more stably as a result.

In a preferred embodiment of the present invention, the status change is carried out via a change in the polarity of the status line. Changing the polarity is a simple step in order to indicate a readiness to receive. Indicating the readiness to receive via a change in polarity also has the advantage that, in comparison to brief switching, it can be guaranteed, despite the asynchronicity, that the main processor reads the status without interrupt at least once. Due to the change in polarity, flanks on the status line can be recognized via constant queries. Advantageously, changing only takes place between two polarity values.

In a further preferred embodiment of the present invention, a protocol version is transmitted and aligned before the first data transmission. The protocol, for example, regulates the number of data per transmission and the structure of the data. Aligning the protocol version before the first data transmission ensures that both systems assume the same transmission length. It is thus avoided that a processor does not receive a portion of the data.

According to an example embodiment of the present invention, preferably, the protocol version is transmitted until the match has been confirmed via the main processor and the sub-processor. Although the protocol version was sent before the first data transmission, it is possible that a processor does not obtain the protocol version due to transmission errors. Retransmission increases the chance that the corresponding processor has at least once completely obtained the protocol version. Confirming the protocol version can ensure that the protocol version has been obtained and that the data can be completely received in the following data transmission.

In an advantageous development of the present invention, a transmission end is ascertained via a predefined number of transmitted data. An end of the transmission can be unambiguously determined by the predefined number of data. As a result, in the event of disturbed and incomplete data transmission, this error can be detected. Errors in the data transmission can thereby be minimized.

Advantageously, an initial value for the status line is set to low before a first data transmission or after a reset. In this case, the “low” value is the lower polarity value in comparison to the “high” value. Before data transmission, the main processor only measures a change in the polarity between low and high. The low value preferably corresponds to the state of the status line during a reset. By setting the initial value to low, a change in status that triggers data transmission is not indicated to the main processor. It is thus avoided that, after a reset, switching on the sub-processor results in data transmission during which the data are lost. Data loss can thus be prevented by the corresponding choice of the initial value.

In a further advantageous embodiment of the present invention, availability of the respectively other system is continuously checked. In this case, it is checked whether the respectively other system is not shut down. This prevents data from being transmitted to a shut-down system, and thus prevents a transmission error from occurring.

The object of the present invention may additionally be achieved by a device for carrying out such a method. The device comprises a main processor, a sub-processor, data transmission lines between the main processor and the sub-processor, and a status line, via which a readiness of the sub-processor to transmit data can be communicated to the main processor. Such a device differs from conventional devices in that a separate status line is present, with which the readiness to receive can be indicated. With such a device, the advantages mentioned regarding the method are substantially achieved.

According to an expedient embodiment of the present invention, at least one further line is present, with which availability of the respectively other processor can be checked. Via such a line, it can permanently be checked whether the respectively other system is not shut down. Data transmission errors are thereby prevented. Two further lines are advantageously provided for checking the respectively other processor.

Exemplary embodiments of the present invention are illustrated in the figures and explained in more detail in the following description.

### BRIEF DESCRIPTION OF THE DRAWINGS

FIG. 1 shows an exemplary embodiment of a device for carrying out the method according to an example embodiment of the present invention

FIG. 2 shows an exemplary embodiment of a method for data exchange, according to the present invention.

### DETAILED DESCRIPTION OF EXAMPLE EMBODIMENTS

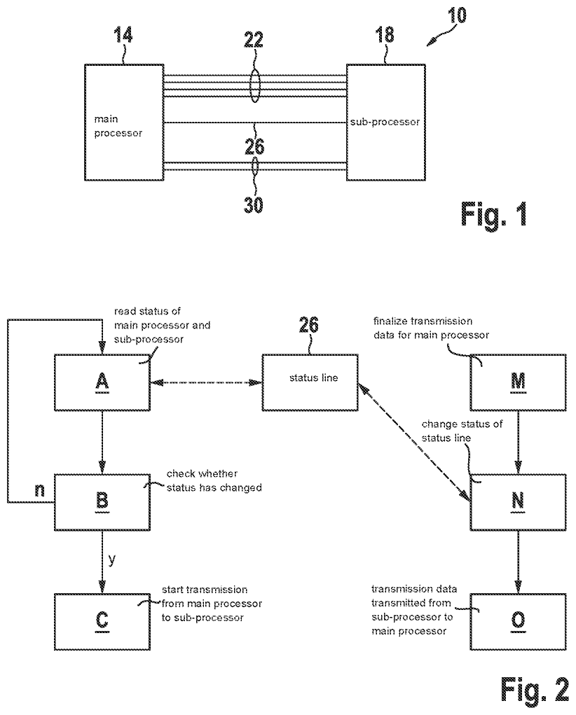

FIG. 1 shows an exemplary embodiment of a device 10 for carrying out the method. The device 10 comprises a main processor 14, with which communication is started. Additionally, the device 10 comprises a sub-processor 18. A data transmission line 22 is arranged between the main processor 14 and the sub-processor 18. The data transmission line 22 is designed as a serial peripheral interface (SPI) data transmission line, which comprises a master-in-slave-out (MISO) line, a master-out-slave-in (MOSI) line, a slave select (SS) line, and a clock transmission line (clock). Data can be transmitted between the main processor 14 and the sub-processor 18 via the data transmission line 22. Additionally, a status line 26 is arranged between the main processor 14 and the sub-processor 18, via which status line the sub-processor 18 can indicate a readiness to receive to the main processor 14. In addition, a further line 30 is in each case provided between the main processor 14 and the sub-processor 18, with which further line the availability of the sub-processor 18 or of the main processor 14 can be checked.

FIG. 2 shows an exemplary embodiment of a method for data exchange. The figure shows the method steps of the main processor 14 and of the sub-processor 18. In a first method step A of the main processor 14, a status of the status line 26 is read. In a subsequent step B, it is checked whether the status has changed. If this is not the case, the first step A is started again. At the same time, the sub-processor 18 also performs a first method step M. In this step M, the transmission data for the main processor 14 are finalized.

After finalizing the transmission data, the status of the status line 26 is changed in a next step N. The status change is detected by the main processor 14. Accordingly, in a next method step C, data transmission from the main processor 14 to the sub-processor 18 is started. At the same time, in step O, the transmission data are also transmitted from the sub-processor 18 to the main processor 14. As a result, it is accordingly possible to transmit data between the two processors 14, 18 without synchronization of the processors 14, 18 and without an interrupt.

What is claimed is:

1. A method for data exchange between a main processor and at least one sub-processor running asynchronously to the main processor, comprising the following steps:
continuously querying a status line for the data transmission by the main processor;
preparing transmission data of the sub-processor for the main processor;
changing a status of the status line via the sub-processor; and
starting data transmission from the main processor to the sub-processor, and simultaneously transmitting the transmission data from the sub-processor to the main processor.

2. The method according to claim 1, wherein the change of the status is carried out via a change in a polarity of the status line.

3. The method according to claim 1, wherein a protocol version is transmitted and aligned before the first data transmission.

4. The method according to claim 3, wherein the protocol version is transmitted until a match has been confirmed via the main processor and the sub-processor.

5. The method according to claim 1, wherein a transmission end is ascertained via a predefined number of transmitted data.

6. The method according to claim 1, wherein an initial value for the status line is set to low before a first data transmission or after a reset.

7. The method according to claim 1, wherein availability of one of sub-processor or the main processor is continuously checked by the other of the other of the sub-processor or the main processor.

8. A device configured for data exchange between a main processor and at least one sub-processor running asynchronously to the main processor, the device comprising:
the main processor;
the sub-processor;
a data transmission line between the main and sub-processor; and
a status line via which a readiness of the sub-processor to transmit data can be communicated to the main processor;
wherein the device is configured to:
continuously query the status line for the data transmission by the main processor;
prepare transmission data of the sub-processor for the main processor;
change a status of the status line via the sub-processor; and
start data transmission from the main processor to the sub-processor, and simultaneously transmit the transmission data from the sub-processor to the main processor.

9. The device according to claim 8, further comprising:
at least one further line with which availability of one of sub-processor or the main processor can be checked by the other of the other of the sub-processor or the main processor.
